(19) United States
(12) Patent Application Publication
(10) Pub. No.: US 2016/0179803 A1
(43) Pub. Date: Jun. 23, 2016

(54) AUGMENTING METADATA USING COMMONLY AVAILABLE VISUAL ELEMENTS ASSOCIATED WITH MEDIA CONTENT

(71) Applicant: Rovi Guides, Inc., Santa Clara, CA (US)

(72) Inventor: Akshat Agarwal, Delhi (IN)

(21) Appl. No.: 14/579,685

(22) Filed: Dec. 22, 2014

(51) Int. Cl. G06F 17/30

(52) U.S. Cl. CPC G06F 17/30038; G06F 17/3053; G06F 17/30029

(57) ABSTRACT

Methods and systems are described herein for improving the metadata available for describing any given media asset. The metadata may be sourced from any known form of media, such as a poster, fan art, a trailer, an audio advertisement, and the like. As an example, if a user were to capture an image of a movie poster, information of the poster may be parsed and analyzed in order to learn information about the movie. The information could be analyzed to determine which aspects of the poster are more important than others (e.g., actors appearing in the poster may be more important than actors already named in a database, but whom do not appear in the poster), and this information could be used to supplement or replace editorial information presently in place in a database.

### BACKGROUND

As the sheer volume of digital entertainment expands at an ever-increasing rate, a problem of how to discover content that interests a given user becomes evermore difficult to solve. Typically, metadata that is databased about any particular media asset is entered by an editor. For example, if an editor is populating metadata about a movie in a database, the editor may limit the data to a few lead actors, and only one or two most applicable genres (out of a possible five applicable genres, for example). If the metadata of a database describing media assets were to be supplemented and organized based on information that is automatically analyzed and parsed into meaningful metadata describing the media assets, the metadata of the database would more accurately describe media assets.

### SUMMARY

Methods and systems are described herein for improving the metadata available for describing any given media asset. The metadata may be sourced from any known form of media, such as a poster, fan art, a trailer, an audio advertisement, and the like. As an example, if a user were to capture an image of a movie poster, information of the poster may be parsed and analyzed in order to learn information about the movie. The information could be analyzed to determine which aspects of the poster are more important than others (e.g., actors appearing in the poster may be more important than actors already named in a database, but who do not appear in the poster), and this information could be used to supplement or replace editorial information presently in place in a database.

In some aspects, control circuitry may receive an image or audio that is associated with a media asset. For example, control circuitry may retrieve a photograph of a movie poster advertising the upcoming release of the movie “Toy Story 4.” Control circuitry may then identify a plurality of information that describes the media asset from the image or the audio. For example, control circuitry may identify that the names of various actors in the movie “Toy Story 4” are listed on the poster.

Control circuitry may then retrieve known information about the media asset from a database. For example, control circuitry may retrieve a list of lead actors that an editor populated into a database entry corresponding to the movie “Toy Story 4.” Control circuitry may subsequently determine a relative importance of first information of the plurality of information as compared to both second information of the plurality of information and the known information. Control circuitry may determine the relative importance of two different pieces of information about actors in the movie “Toy Story 4” within the poster, for example, by comparing the font size of each actor's name, and concluding that an actor's name that is cast in a larger font size corresponds to an actor who is more important than a different actor whose name is cast in a smaller font size. Control circuitry may determine a relative importance of the information in the poster (e.g., the actors' names) as compared to, for example, editorial information in the database, by determining that an actor's name that was listed in the poster is not listed in the database, and because the actor in the database is not named in the poster, the actor in the database is less important than the actor named in the poster.

After determining relative importance of each piece of information, control circuitry may transmit a command to the database. The command may include an instruction to store the first information and second information in the database in a data structure that includes the known information. For example, the command in the example above would cause the information from the movie poster about “Toy Story 4” to supplement the database entry that was drafted by an editor, such that it includes the additional information from the poster not previously in the database. The command may also include an instruction to organize the information from the poster and previously databased information based on the determined relative importance. For example, the command may organize a list of actors based on whether the actor was listed on the poster but not listed in the editorial data of the database, and also based on the relative font sizes that the actors' names were displayed in the poster.

In some embodiments, control circuitry may determine a level of emphasis of the first information in the image or audio, and may also determine a level of emphasis of the second information in the image or audio. For example, control circuitry may determine that a portrayal of one actor in a movie poster is in the foreground of the poster, and a portrayal of another actor is in the background of the poster. Control circuitry may conclude therefrom that the actor in the foreground has a high level of emphasis, and the actor in the background has a low level of emphasis.

Control circuitry may then compare the level of emphasis of the first information to the level of emphasis of the second information. Following from the example above, control circuitry may, upon comparison of an actors' relative level of emphasis, that the actor portrayed in the foreground has a greater level of emphasis than the actor portrayed in the background. Based on this comparison, control circuitry may determine that the first information is relatively more important than the second information. In other words, control circuitry may determine that the actor in the foreground is relatively more important than the actor in the background, and may cause this relative level of importance to be reflected in the manner in which these actors are databased in an entry corresponding to the movie they appear in is organized.

In some embodiments, control circuitry may determine the level of emphasis of the first information based on at least one of font size, font type, font color, object size, object color, object placement, depth of object with relation to a foreground or a background of an image, audio volume, and audio type. For example, any of these bases may replace the example above, where control circuitry relied upon the relative depths of the actors' portrayals with relation to the foreground and background of the movie poster.

In some embodiments, control circuitry may identify third information of the plurality of information, and may determine a type of information of the third information. For example, if the information is being retrieved from a movie poster, a release date may be identified of Aug. 2, 2014. Control circuitry may determine that the release date is of the type “release date.” Control circuitry may then retrieve data populated in a field of the known information, wherein the field corresponds to the determined type. As an example, control circuitry may retrieve a release date populated by the editor of May 2, 2014. The release date populated by the editor may be out-of-date, as the release date may have been postponed due to delays in production. Control circuitry may determine whether the third information matches the retrieved data, and may replace the retrieved data with the third information if the third information does not match the retrieved data. For example, control circuitry may recognize that the release dates do not match, and may replace the now outdated release date of May 2, 2014, with the updated release date from the movie poster of Aug. 2, 2014.

In some embodiments, control circuitry may identify a context of each information of the plurality of information. For example, if the information is pulled from a movie poster for the movie “Toy Story 4,” a lack of people in the poster may indicate that the movie is a cartoon, and the use of bright colors may indicate that the movie is an adventure movie. Control circuitry may retrieve a mapping of a plurality of contexts to a plurality of genres. The mapping may, for example, inform control circuitry that the genres “cartoon” and “adventure” correspond to a context where no person is in an image frame, or where bright colors are in an image frame, respectively.

Control circuitry may, based on the identified contexts and the retrieved mappings, determine a set of genres associated with the plurality of information by cross-referencing the context of each information of the plurality of information against the mapping. For example, as described above, control circuitry may cross-reference the context of “no people” to the mapping to learn of the genre of “cartoon.” Control circuitry may then retrieve a plurality of genre weightings associated with the media asset from the database. For example, control circuitry may already learn that “Toy Story 4” is already associated with the genres of cartoon, adventure, and children, and that the genre of cartoon is weighted 4 times that of a base weighting, the genre of adventure is weighted 2 times that of a base weighting, and the genre of children is weighted 1 time that of a base weighting. Control circuitry may update the plurality of genre weightings by incrementing each genre weighting for which a genre of the set of genres matches. Following the example above, control circuitry may increment each weighting by one unit based on the identified contexts, such that the genre of cartoon is now weighted 5 times that of a base weighting, and the genre of adventure is now weighted 3 times that of a base weighting. Control circuitry may then transmit a command to the database to replace the plurality of genre weightings with the updated plurality of genre weightings. For example, this command would cause the old weightings to be replaced by those incremented where appropriate.

In some embodiments, prior to updating the plurality of genre weightings, control circuitry may determine whether a genre of the set of genres is diametrically opposed to a genre with a genre weighting that is above a threshold. For example, control circuitry may determine that the character of Woody in a poster advertising “Toy Story 4” is a person, and therefore the context is one which includes people, and therefore is associated with an adult show. Control circuitry may also learn that metadata already databased about “Toy Story 4” indicates that “Toy Story 4” is associated with the genre of “cartoon,” and that the “cartoon” genre has a weighting of six units. Control circuitry may learn (e.g., by communicating with the database), that a threshold associated with incrementing a genre weighting is five units. Control circuitry may, based on learning that the genre of “cartoon” is a highly weighted genre, where the genre exceeds the threshold, determine that the context being one which includes people is diametrically opposed to the genre of “cartoon.” Accordingly, in response to determining that the genre of the set of genres is diametrically opposed to the genre with the genre weighting that is above the threshold, control circuitry may refrain from updating a genre weighting corresponding to the genre of the set of genres. In other words, control circuitry would not increment the adult genre in this example because it is diametrically opposed to the cartoon genre.

In some embodiments, control circuitry may perform facial recognition on a face of the image to identify a person associated with the media asset. For example, if the image is a frame of a movie trailer including the actor Tom Cruise, control circuitry may identify that the actor of the frame is Tom Cruise based on facial recognition. Control circuitry may then transmit a command to the database to denote the identified person in the data structure as a person of importance. For example, because Tom Cruise was included in the movie trailer, control circuitry may conclude that Tom Cruise is an important actor in the movie associated with the trailer, and may indicate this fact in the database.

In some embodiments, control circuitry may retrieve a user profile associated with a user. For example, if a user is browsing media asset identifiers for a media asset the user may enjoy viewing, control circuitry may retrieve the user's profile. Control circuitry may also retrieve data of the data structure, which includes the updated data including information that control circuitry has learned from an image or audio pertaining to a media asset. Control circuitry may then cross-reference data of the user profile against the data of the data structure, determine a recommendation based on the cross-referencing, and cause the recommendation to be provided to the user. For example, if the user enjoys television shows including the actor Seth Green, and the database has been updated to indicate that the actor Seth Green is in “Family Guy” based on an image indicating as much, the show “Family Guy” may be recommended to the user.

In some embodiments, control circuitry may receive a request for information corresponding to the media asset. For example, a user may request information about an episode of the television show “Family Guy.” Control circuitry may retrieve data of the data structure, and may cause the generation of a display of information corresponding to the media asset, wherein the information is organized according to the determined relative importance. For example, the particular episode may have a focus on the character Brian Griffin; however, editorial data about the episode may indicate the list of characters in an order where Brian Griffin appears third or fourth, as it is unusual for Brian Griffin to be a lead character in an episode. Control circuitry may learn of Brian's importance in this particular episode based on the systems and methods described above and below, and when presenting information to this particular user, may emphasize that Brian is the lead character in this episode.

It should be noted that the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative embodiment of a display screen that may be used to provide media guidance application listings and other media guidance information, in accordance with some embodiments of the disclosure;

FIG. 2 shows another illustrative embodiment of a display screen that may be used to provide media guidance application listings, in accordance with some embodiments of the disclosure;

FIG. 3 is a block diagram of an illustrative user equipment (UE) device in accordance with some embodiments of the disclosure;

FIG. 4 is a block diagram of an illustrative media system in accordance with some embodiments of the disclosure;

FIG. 5 shows an illustrative embodiment of an image indicating data that may be processed to populate data about a media asset, in accordance with some embodiments of the disclosure; and

FIG. 6 is a flowchart of illustrative steps involved in populating data about a media asset in a database in a manner that reflects the relative importance of each object, in accordance with some embodiments of the disclosure.

### DESCRIPTION

Methods and systems are described herein for improving the metadata available for describing any given media asset. In some embodiments, control circuitry may receive an image or audio that is associated with a media asset. For example, control circuitry may retrieve a photograph of a movie poster advertising the upcoming release of the movie “Toy Story 4.” Control circuitry may then identify a plurality of information that describes the media asset from the image or the audio. For example, control circuitry may identify that the names of various actors in the movie “Toy Story 4” are listed on the poster.

Control circuitry may then retrieve known information about the media asset from a database. For example, control circuitry may retrieve a list of lead actors that an editor populated into a database entry corresponding to the movie “Toy Story 4.” Control circuitry may subsequently determine a relative importance of first information of the plurality of information as compared to both second information of the plurality of information and the known information. Control circuitry may determine the relative importance of two different pieces of information about actors in the movie “Toy Story 4” within the poster, for example, by comparing the font size of each actor's name, and concluding that an actor's name that is cast in a larger font size corresponds to an actor who is more important than a different actor whose name is cast in a smaller font size. Control circuitry may determine a relative importance of the information in the poster (e.g., the actors' names) as compared to, for example, editorial information in the database, by determining that an actor's name that was listed in the poster is not listed in the database, and because the actor in the database is not named in the poster, the actor in the database is less important than the actor named in the poster.

After determining relative importance of each piece of information, control circuitry may transmit a command to the database. The command may include an instruction to store the first information and second information in the database in a data structure that includes the known information. For example, the command in the example above would cause the information from the movie poster about “Toy Story 4” to supplement the database entry that was drafted by an editor, such that it includes the additional information from the poster not previously in the database. The command may also include an instruction to organize the information from the poster and previously databased information based on the determined relative importance. For example, the command may organize a list of actors based on whether the actor was listed on the poster but not listed in the editorial data of the database, and also based on the relative font sizes that the actors' names were displayed in the poster.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

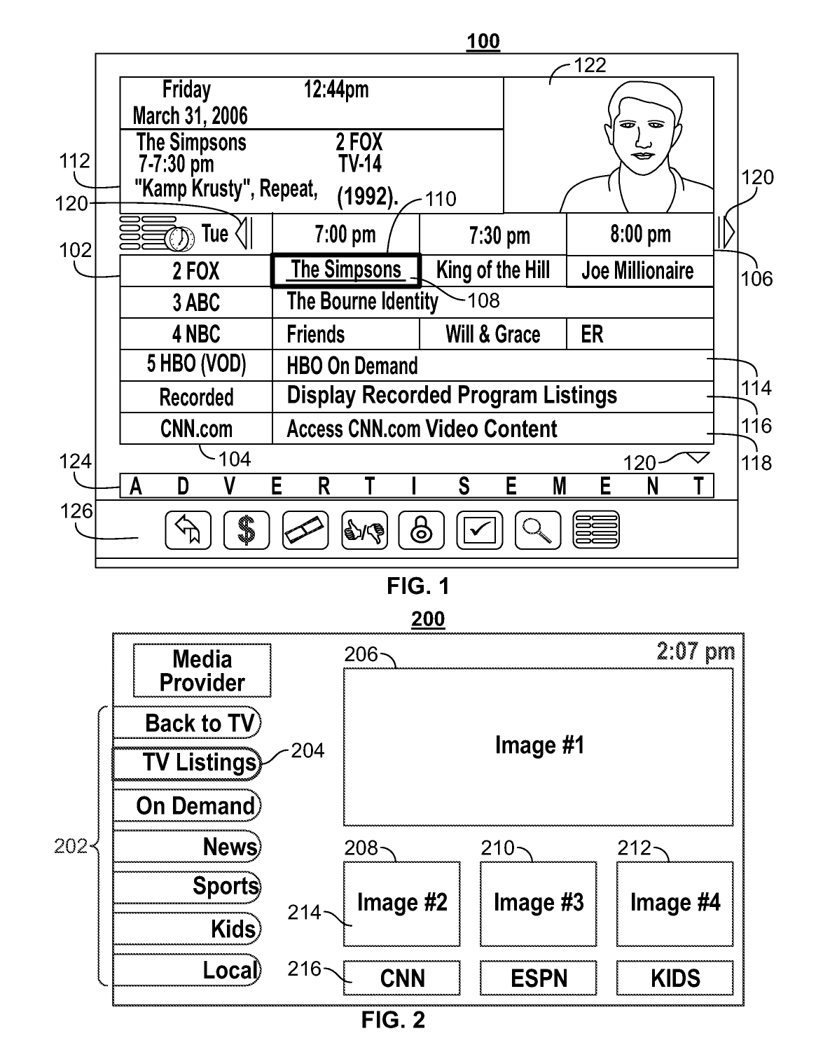

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

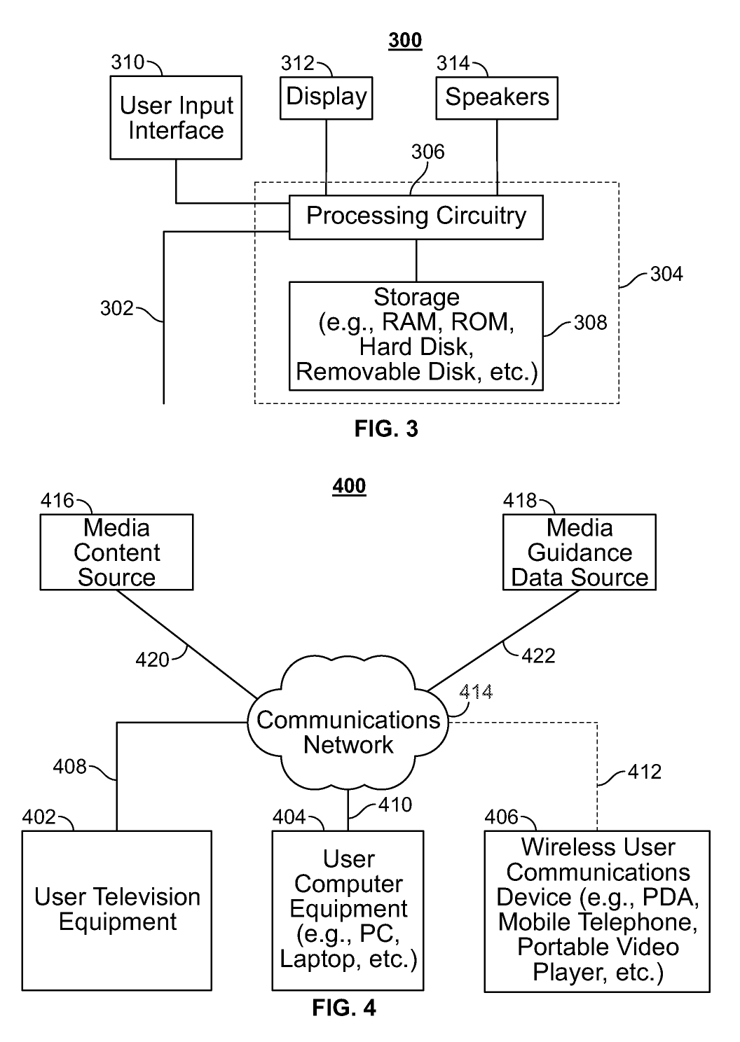

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 312 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

The term “image” wherever used in this disclosure in reference to a media asset is defined to mean any image that describes the media asset. This may, for example, be a photograph, a poster, fan art, box art, a printed or digital advertisement, a frame of a video (e.g., a frame of a trailer), textual data of printed matter such as a newspaper or magazine that is captured by control circuitry, and the like.

The term “audio” wherever used in this disclosure in reference to a media asset is defined to mean any audio that describes the media asset. This audio may be a voice clip from the media asset, audio associated with a video describing the media asset (e.g., a trailer), audio from an actor of the media asset (e.g., during an interview), and the like.

The term “context” wherever used in this disclosure is defined to mean an ancillary portion of an image, object, or audio that is not necessary to portray the image or object itself, but is necessary to explain a state of being, situation, atmosphere, or background surrounding the image, object, or audio. This is better explained by example. An example of a context is blood appearing on an object portraying a character. Blood is not necessary to portray the character, but is necessary to explain the character's state of being. Other non-limiting examples include background color, clothing (or lack thereof), clouds or sunshine, contrast of an image, facial characteristics of a character (e.g., smiling, frowning or crying) that imply a mood or happenstance of the character, screams or shrieks occurring in audio, gunshots occurring in audio, and the like.

In some embodiments, control circuitry may receive an image or audio that is associated with a media asset. For example, control circuitry may retrieve a photograph of a movie poster advertising the upcoming release of the movie “Toy Story 4.” Control circuitry may then identify a plurality of information that describes the media asset from the image or the audio. For example, control circuitry may identify that the names of various actors in the movie “Toy Story 4” are listed on the poster.

Control circuitry may then retrieve known information about the media asset from a database. For example, control circuitry may retrieve a list of lead actors that an editor populated into a database entry corresponding to the movie “Toy Story 4.” Control circuitry may subsequently determine a relative importance of first information of the plurality of information as compared to both second information of the plurality of information and the known information. Control circuitry may determine the relative importance of two different pieces of information about actors in the movie “Toy Story 4” within the poster, for example, by comparing the font size of each actor's name, and concluding that an actor's name that is cast in a larger font size corresponds to an actor who is more important than a different actor whose name is cast in a smaller font size. Control circuitry may determine a relative importance of the information in the poster (e.g., the actors' names) as compared to, for example, editorial information in the database, by determining that an actor's name that was listed in the poster is not listed in the database, and because the actor in the database is not named in the poster, the actor in the database is less important than the actor named in the poster.

After determining the relative importance of each piece of information, control circuitry may transmit a command to the database. The command may include an instruction to store the first information and second information in the database in a data structure that includes the known information. For example, the command in the example above would cause the information from the movie poster about “Toy Story 4” to supplement the database entry that was drafted by an editor, such that it includes the additional information from the poster not previously in the database. The command may also include an instruction to organize the information from the poster and previously databased information based on the determined relative importance. For example, the command may organize a list of actors based on whether the actor was listed on the poster but not listed in the editorial data of the database, and also based on the relative font sizes that the actors' names were displayed in the poster.

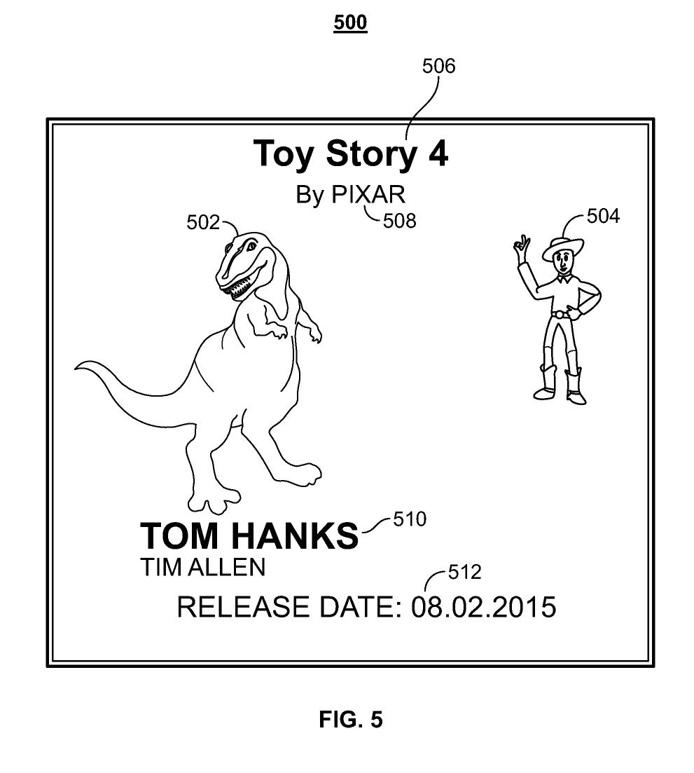

FIG. 5 shows an illustrative embodiment of an image indicating data that may be processed to populate data about a media asset, in accordance with some embodiments of the disclosure. While image 500 is depicted to be a screen capture of a movie poster, image 500 may be any image as defined above and below, such as, for example, a photograph, a poster, fan art, box art, a printed or digital advertisement, a frame of a video (e.g., a frame of a trailer), textual data of printed matter such as a newspaper or magazine that is captured by control circuitry, and the like. Control circuitry 304 may receive an image or audio that is associated with a media asset. For example, control circuitry 304 may receive image 500, which describes the media asset “Toy Story 4.”

Control circuitry 304 may receive image 500 by retrieving it from local storage, such as storage 308, or a remote database, such as media content source 416 (e.g., by requesting to receive image 500 from media content source 416 via communications network 414). Control circuitry 304 may alternatively receive image 500 from a user via user input interface 310, where a user inputs image 500 from, e.g., a camera device. Image 500 is used to describe various embodiments of the disclosure, but the discussion above and below equally applies where control circuitry 304 receives audio, for example via user input interface 310 (e.g., a microphone) or speakers 314 (where control circuitry 304 detects the audio from speakers 314 via, e.g., a microphone).

Control circuitry 304 may determine that image 500 describes the media asset “Toy Story 4” using any known technique. For example, control circuitry 304 may detect a watermark in image 500 that describes image 500 to be describing the media asset “Toy Story 4.” Similarly, if control circuitry 304 were to detect audio instead of image 500, control circuitry 304 may detect a watermark within the audio that identifies the audio to be describing the media asset “Toy Story 4.” As another example, control circuitry 304 may determine that image 500 describes the media asset “Toy Story 4” by determining that title field 506 states that image 500 pertains to the media asset “Toy Story 4.” As another example, control circuitry 304 may identify object 502 to be the character Rex, and object 504 to be the character Woody, both of which are characters appearing in the media asset “Toy Story 4.” Control circuitry 304 may additionally detect that release date 512 indicates that the media asset described by image 500 has not yet been released. Control circuitry 304 may cross-reference the information learned from the characters of image 500 and release date 512 of image 500 against an entry of a database (e.g., media guidance data source 418) to learn that image 500 describes the media asset “Toy Story 4.”

Control circuitry 304 may identify a plurality of information that describes the media asset from the image or the audio. For example, control circuitry 304 may apply optical character recognition (“OCR”) to image 500 to learn that title field 506 describes image 500 to be pertaining to the media asset “Toy Story 4,” that developer field 508 describes image 500 to be pertaining to the developer “PIXAR,” that actor field 510 describes image 500 to be pertaining to the actors Tom Hanks and Tim Allen, and that release date field 512 describes image 500 to be pertaining to a release date of Aug. 2, 2015. Control circuitry 304 may identify other information from the OCR process that describes the media asset, at least by implicit description, such as relative size of the text of fields 506, 508, 510, and 512.

Control circuitry 304 may also identify non-textual information such as characters 502 and 504, as well as any colorings or patterns in image 500. Control circuitry 304 may identify information based on how characters 502 and 504 are represented as well. For example, control circuitry 304 may identify that character 502 is bleeding, or that character 504 is naked. If control circuitry were to have received audio instead of or in addition to image 500, control circuitry 304 may identify further information, such as voice patterns, background music, screams or shrieks, and any other audio information.

Control circuitry 304 may assign meaning to the identified information by cross-referencing media guidance data source 418 to determine the meaning of each identified information. For example, control circuitry 304 may identify that character 502 is Rex from the media asset “Toy Story 4” by cross-referencing character 502 against a database of characters. As another example, control circuitry 304 may determine that characters 502 and 504 are cartoons, that the light coloring in image 500 indicates that it is a children's movie. As another example, if character 502 were bleeding, control circuitry 304 may determine that image 500 describes a horror movie, and if character 504 were naked, control circuitry 304 may determine that image 500 describes adult media. As yet another example, if control circuitry 304 were to detect screaming in audio, control circuitry 304 may determine that the media asset described by the audio is of the “horror” genre.

In some embodiments, control circuitry 304 may retrieve known information about the media asset described by the image (e.g., image 500) or audio from a database (e.g., media guidance data source 418). For example, editors often populate information about a media asset for various purposes, such as providing interested users further information, providing recommendations to users by comparing a user's profile against the editorial information to determine a media asset a user is likely to enjoy, etc. As another example, the known information may include information automatically learned about the media asset (e.g., through the systems and methods described in this disclosure).

In some embodiments, control circuitry 304 may determine a relative importance of first information of the plurality of information as compared to second information of the plurality of information. For example, when control circuitry 304 analyzes image 500, control circuitry 304 may determine that actors field 510 include actors' names listed in varying font sizes. As depicted in image 500, actor Tom Hanks of actors field 510 is listed in larger font than Tim Allen of actors field 510. Control circuitry 304 may determine that Tom Hanks is a relatively more important actor in “Toy Story 4” as compared to Tim Allen based on the font sizes of actors field 510. As another example, control circuitry 304 may determine that character 502 is depicted in the foreground of image 500, whereas character 504 is depicted in the background of image 500. Accordingly, control circuitry 304 may determine that the character Rex, which corresponds to character 502, is relatively more important than the character Woody, which corresponds to character 504, in the media asset “Toy Story 4.”

Control circuitry 304 may also determine a relative importance of the first information as compared to the known information (i.e., the information retrieved from media guidance data source 418). For example, control circuitry 304 may determine that media guidance data source 418 lists a release date for “Toy Story 4” of May 2, 2015. Control circuitry 304 may determine that image 500 lists a release date for “Toy Story 4” of Aug. 2, 2015. Control circuitry 304 may determine that image 500 was created more recently than the database information listing the release date was populated. Therefore, control circuitry 304 may determine that the release date listed on image 500 is more important than the release date information of the database. As another example, the database may list Woody as a lead character in “Toy Story 4,” and may list Rex as a supporting character, as this is consistent with Woody and Rex's role in early iterations of the media assets of the “Toy Story” series. Control circuitry 304 may determine, however, that because character 502, which corresponds to Rex, is depicted more prominently than character 504, which corresponds to Woody, Rex is a more important character than Woody is in “Toy Story 4.” Control circuitry 304 may therefore determine that Rex is a more prominent character than Woody is more important information than the information listed in the database regarding these characters.

In some embodiments, control circuitry 304 may transmit a command to the database (e.g., media guidance data source 418) to store the first information and second information in the database in a data structure that includes the known information. For example, control circuitry 304 may send the information learned, as discussed above and below, from image 500, to media guidance data source 418, and may instruct media guidance data source 418 to store the information in a data structure that includes information that was already stored at media guidance data source 418. As an example, if media guidance data source 418 previously listed Woody as the sole lead character, the command sent by control circuitry 304 would instruct media guidance data source 418 to include Rex as a lead character as well, as Rex is prominently depicted in image 500.

In some embodiments, the command to media guidance data source 418 may additionally include an instruction to organize the first information, the second information, and the known information in the database based on the determined relative importance. For example, if media guidance data source 418 previously reflected that Woody was the most prominent character in “Toy Story 4,” and control circuitry 304 determined that Rex is in fact a more prominent character than Woody based on the relative emphasis of character 502 in image 500 as compared to the relative emphasis of character 504, the instruction sent to media guidance data source 418 by control circuitry 304 may include an instruction to list Rex as a first lead character in “Toy Story 4,” and Woody as a second lead character in “Toy Story 4,” thus causing media guidance data source 418 to organize the information learned by control circuitry 304 based on image 500, as well as the information previously known to media guidance data source 418, in order of relative importance.

In some embodiments, control circuitry 304 may determine a level of emphasis of the first information in the image (e.g., image 500) or audio and a level of emphasis of the second information in the image or audio. Control circuitry 304 may determine the level of emphasis based on at least one of font size, font type, font color, object size, object color, object placement, depth of object with relation to a foreground or a background of an image, audio volume, and audio type, as described above and below. For example, control circuitry may determine a high level of emphasis of character 502 in image 500 because character 502 is the largest character in image 500, and may determine a low level of emphasis of character 504 in image 500 because character 504 is the smallest character in image 500.

Control circuitry 304 may compare the level of emphasis of the first information to the level of emphasis of the second information. For example, control circuitry 304 may compare the level of emphasis of characters 502 and 504, and may determine that the level of emphasis of character 502 is greater than that of 504, based on the description above. In such a circumstance, control circuitry 304 may determine that the first information is relatively more important than the second information. For example, control circuitry 304 may determine that the character Rex, which is associated with character 502, is relatively more important than the character Woody, which is associated with character 504, in the media asset “Toy Story 4” based on their relative levels of emphasis.

In some embodiments, control circuitry 304 may identify third information of the plurality of information from image 500, and may determine a type of information of the third information. For example, control circuitry 304 may identify release date 512 listed on image 500 as being of the type “release date.” Control circuitry 304 may retrieve data populated in a field of the known information (e.g., from media guidance data source 418), wherein the field corresponds to the determined type. For example, control circuitry 304 may retrieve a projected release date stored in media guidance data source 418 for the media asset described by image 500. Control circuitry 304 may then determine whether the third information matches to the retrieved data, and replace the retrieved data with the third information if the third information does not match the retrieved data. As an example, control circuitry 304 may determine that the release date listed on image 500 of Aug. 2, 2015, does not match the projected release date stored in media guidance data source of May 2, 2015, and may replace the stored release date with the release date listed on image 500.

In some embodiments, control circuitry 304 may identify a context of each information of the plurality of information. For example, control circuitry 304 may determine that character 502 of image 500 is bleeding, and that character 504 of image 500 is carrying a gun. Control circuitry 304 may retrieve a mapping of a plurality of contexts to a plurality of genres (e.g., from media guidance data source 418 via communications network 414). As an example, control circuitry 304 may learn from the mapping that blood maps to the genres “violent,” “action,” “horror,” and “adult.” As another example, control circuitry 304 may learn from the mapping that a gun maps to the genres “violent,” “action,” and “western.” Accordingly, control circuitry 304 may determine a set of genres associated with the plurality of information of image 500 by cross-referencing the context of each object of image 500 against the mapping retrieved from media guidance data source 418.

Control circuitry 304 may retrieve a plurality of genre weightings associated with the media asset described by image 500 or associated audio from the database (e.g., media guidance data source 418). For example, control circuitry may gather genre weightings input by an editor with respect to the media asset “Toy Story 4” including a weighting of 5 for the genre “children,” a weighting of 4 for the genre “cartoon,” and a weighting of 3 for the genre “action.” Control circuitry 304 may update the plurality of genre weightings by incrementing each genre weighting for which a genre of the set of genres matches. For example, control circuitry 304 may update the editor-input genres by incrementing them by one unit for each genre implied by the context of image 500. Thus, a unit will be added to the genres “violent,” “action,” and “horror” as a result of control circuitry 304 identifying the context of blood, and a unit will be added to the genres “violent,” “action,” and “western” as a result of control circuitry 304 identifying the context of a gun. Control circuitry 304 may then transmit a command to the database (e.g., media guidance data source 418) to replace the plurality of genre weightings with the updated plurality of genre weightings.

Those familiar with the media asset “Toy Story 4” would recognize that “Toy Story 4” is not at all a “horror” film, and therefore incrementing a weighting associated with the genre “horror” would cause the data known to control circuitry 304 via media guidance data source 418 to not be improved in some circumstances. Accordingly, as a safeguard to this result, control circuitry 304 may, prior to updating the plurality of genre weightings, determining whether a genre of the set of genres is diametrically opposed to a genre with a genre weighting that is above a threshold. For example, control circuitry 304 may determine from media guidance data source 418 that the genre of “children” is diametrically opposed to the genre of “horror.” Furthermore, control circuitry 304 may determine that the weighting of the genre “children” assigned to the media asset “Toy Story 4” is a weighting of 5, and that the threshold weighting is 3. In response to determining that the genre of the set of genres is diametrically opposed to the genre with the genre weighting that is above the threshold, control circuitry 304 may refrain from updating a genre weighting corresponding to the genre of the set of genres. As described in the foregoing, control circuitry 304 may refrain from incrementing a genre weighting for “horror” in connection with the media asset “Toy Story 4” based on this safeguard mechanism, thus avoiding mistakenly assigning a genre to “Toy Story 4” based on misinterpreted information from image 500.

In some embodiments, control circuitry 304 may perform facial recognition on a face of the image (e.g., image 500) to identify a person associated with the media asset. For example, control circuitry 304 may analyze the face of character 502 of image 500 and determine, using facial recognition, that character 502 is an image of Tom Cruise. Control circuitry 304 may then transmit a command to the database (e.g., media guidance data source 418) to denote the identified person (e.g., Tom Cruise) in the data structure as a person of importance. For example, control circuitry 304 may determine that because Tom Cruise appears in image 500, Tom Cruise must be a lead actor, and therefore should be listed as such in connection with the media asset image 500 describes in media guidance data source 418. This embodiment is equally applicable to audio analyzed by control circuitry 304, where control circuitry 304 may use voice recognition on the audio to determine who is speaking, and thereafter denote the identified speaker as a person of importance.

In some embodiments, image 500 may be a frame of a video associated with the media asset. Control circuitry 304 may determine the relative importance of the first information (e.g., character 502) based on the relative number of frames of the video that character 502 is associated with as compared to the relative number of frames of the video that the second information (e.g., character 504) is associated with. Alternatively, control circuitry 304 may determine how much time each of character 502 or character 504 appears for in the video, and may determine importance therefrom. Similarly, if audio is used, control circuitry 304 may determine how much time a voice from one person is used relative to a voice used from another person, and may determine relative importance of the person associated with each voice therefrom.

In some embodiments, control circuitry 304 may retrieve a user profile associated with a user (e.g., from media guidance data source 418), and may retrieve data of the data structure (i.e., data that describes the media asset) from media guidance data source 418. Control circuitry 304 may cross-reference data of the user profile against the data of the data structure. For example, control circuitry 304 may determine commonalties between user preferences reflected in the user profile and aspects of the media asset, such as that the user enjoys media assets of the action genre, and that “Toy Story 4” has a high weighting in the action genre, perhaps because the data structure associated with “Toy Story 4” was updated to increment the weighting of the action data structure based on features of image 500. Control circuitry may determine to recommend the media asset described by image 500 (e.g., “Toy Story 4”) based on the cross-referencing, and cause the recommendation to be provided to the user (e.g., via display 312 or speakers 314).

In some embodiments, control circuitry 304 may receive a request for information corresponding to a media asset. For example, a user may be utilizing an interactive media guidance application and interacting with it via user input interface 310 and display 312, and may select “Toy Story 4” (e.g., via user input interface 310) in connection with a request to learn more information about the media asset “Toy Story 4.” Control circuitry 304 may responsively retrieve data of the data structure (e.g., from media guidance data source 418), and may cause the generation of a display of information (e.g., on display 312) corresponding to “Toy Story 4,” where the information is organized according to the determined relative importance. For example, if control circuitry 304 determines that character 502 of image 500 (corresponding to Rex) is more important than character 504 of image 500 (corresponding to Woody) and thus updates media guidance data source 418 to reflect this relative importance in a manner as described above and below, display 312 may show the characters organized in a manner such that Rex is indicated to be more important than Woody to the user.

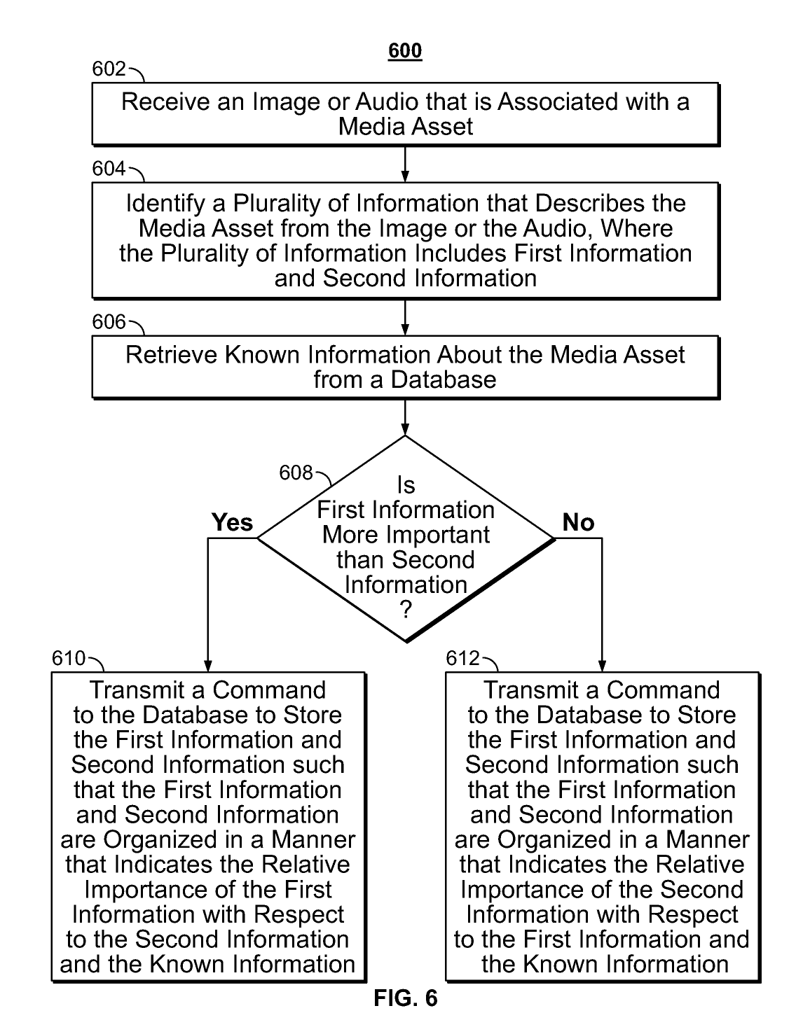

FIG. 6 is a flowchart of illustrative steps involved in populating data about a media asset in a database in a manner that reflects the relative importance of each object, in accordance with some embodiments of the disclosure. It should be noted that process 600 or any step thereof could be performed on, or provided by, any of the devices shown in FIGS. 3-4. For example, process 600 may be executed by control circuitry 304 (FIG. 3) as instructed by control circuitry implemented on user equipment 402, 404, and/or 406 (FIG. 4) in order to determine a relative importance of an object in image 500. In addition, one or more steps of process 600 may be incorporated into or combined with one or more steps of any other process or embodiment described by this disclosure.

Process 600 begins at 602, where control circuitry 304 may receive an image or audio that is associated with a media asset. For example, control circuitry 304 may receive image 500, which describes the media asset “Toy Story 4.” Control circuitry 304 may receive image 500 by retrieving it from local storage, such as storage 308, or a remote database, such as media content source 416 (e.g., by requesting to receive image 500 from media content source 416 via communications network 414). Control circuitry 304 may alternatively receive image 500 from a user via user input interface 310, where a user inputs image 500 from, e.g., a camera device. Image 500 is used to describe various embodiments of the disclosure, but the discussion above and below equally applies where control circuitry 304 receives audio, for example via user input interface 310 (e.g., a microphone) or speakers 314 (where control circuitry 304 detects the audio from speakers 314 via, e.g., a microphone).

Control circuitry 304 may determine that image 500 describes the media asset “Toy Story 4” using any known technique. For example, control circuitry 304 may detect a watermark in image 500 that identifies image 500 to be describing the media asset “Toy Story 4.” Similarly, if control circuitry 304 were to detect audio instead of image 500, control circuitry 304 may detect a watermark within the audio that identifies the audio to be describing the media asset “Toy Story 4.” As another example, control circuitry 304 may determine that image 500 describes the media asset “Toy Story 4” by determining that title field 506 states that image 500 pertains to the media asset “Toy Story 4.” As another example, control circuitry 304 may identify object 502 to be the character Rex, and object 504 to be the character Woody, both of which are characters appearing in the media asset “Toy Story 4.” Control circuitry 304 may additionally detect that release date 512 indicates that the media asset described by image 500 has not yet been released. Control circuitry 304 may cross-reference the information learned from the characters of image 500 and release date 512 of image 500 against an entry of a database (e.g., media guidance data source 418) to learn that image 500 describes the media asset “Toy Story 4.”

Process 600 continues at 604, where control circuitry 304 may identify a plurality of information that describes the media asset from the image or the audio, where the plurality of information includes the first information and the second information. For example, control circuitry 304 may apply optical character recognition (“OCR”) to image 500 to learn that title field 506 describes image 500 to be pertaining to the media asset “Toy Story 4,” that developer field 508 describes image 500 to be pertaining to the developer “PIXAR,” that actor field 510 describes image 500 to be pertaining to the actors Tom Hanks and Tim Allen, and that release date field 512 describes image 500 to be pertaining to a release date of Aug. 2, 2015. Control circuitry 304 may identify other information from the OCR process that describes the media asset, at least by implicit description, such as relative size of the text of fields 506, 508, 510, and 512.

Control circuitry 304 may also identify non-textual information such as characters 502 and 504, as well as any colorings or patterns in image 500. Control circuitry 304 may identify information based how characters 502 and 504 are represented as well. For example, control circuitry 304 may identify that character 502 is bleeding, or that character 504 is naked. If control circuitry were to have received audio instead of or in addition to image 500, control circuitry 304 may identify further information, such as voice patterns, background music, screams or shrieks, and any other audio information.

Control circuitry 304 may assign meaning to the identified information by cross-referencing media guidance data source 418 to determine the meaning of each identified information. For example, control circuitry 304 may identify that character 502 is Rex from the media asset “Toy Story 4” by cross-referencing character 502 against a database of characters. As another example, control circuitry 304 may determine that characters 502 and 504 are cartoons, that the light coloring in image 500 indicates that it is a children's movie. As another example, if character 502 were bleeding, control circuitry 304 may determine that image 500 describes a horror movie, and if character 504 were naked, control circuitry 304 may determine that image 500 describes adult media. As yet another example, if control circuitry 304 were to detect screaming in audio, control circuitry 304 may determine that the media asset described by the audio is of the “horror” genre.

Process 600 continues at 606, where control circuitry 304 may retrieve known information about the media asset described by the image (e.g., image 500) or audio from a database (e.g., media guidance data source 418). For example, editors often populate information about a media asset for various purposes, such as providing interested users further information, providing recommendations to users by comparing a user's profile against the editorial information to determine a media asset a user is likely to enjoy, etc. As another example, the known information may include information automatically learned about the media asset (e.g., through the systems and methods described in this disclosure).

Process 600 continues at 608, where control circuitry 304 may determine a relative importance of first information of the plurality of information as compared to second information of the plurality of information. Specifically, control circuitry 304 may determine whether the first information is more important than the second information. For example, when control circuitry 304 analyzes image 500, control circuitry 304 may determine that actors field 510 include actors listed in varying font sizes. As depicted in image 500, actor Tom Hanks of actors field 510 is listed in larger font than Tim Allen of actors field 510. Control circuitry 304 may determine that Tom Hanks is a relatively more important actor in “Toy Story 4” as compared to Tim Allen based on the font sizes of actors field 510. As another example, control circuitry 304 may determine that character 502 is depicted in the foreground of image 500, whereas character 504 is depicted in the background of image 500. Accordingly, control circuitry 304 may determine that the character Rex, which corresponds to character 502, is relatively more important than the character Woody, which corresponds to character 504, in the media asset “Toy Story 4.”

While not depicted in process 600, process 600 may optionally have control circuitry 304 also determine a relative importance of the first information as compared to the known information (i.e., the information retrieved from media guidance data source 418). For example, control circuitry 304 may determine that media guidance data source 418 lists a release date for “Toy Story 4” of May 2, 2015. Control circuitry 304 may determine that image 500 lists a release date for “Toy Story 4” of Aug. 2, 2015. Control circuitry 304 may determine that image 500 was created more recently than the database information listing the release date was populated. Therefore, control circuitry 304 may determine that the release date listed on image 500 is more important than the release date information of the database. As another example, the database may list Woody as a lead character in “Toy Story 4,” and may list Rex as a supporting character, as this is consistent with Woody and Rex's role in early iterations of the media assets of the “Toy Story” series. Control circuitry 304 may determine, however, that because character 502, which corresponds to Rex, is depicted more prominently than character 504, which corresponds to Woody, Rex is a more important character than Woody is in “Toy Story 4.” Control circuitry 304 may therefore determine that Rex is a more prominent character than Woody is more important information than the information listed in the database regarding these characters.

Process 600 continues to 610 if control circuitry 304 determines that the first information is more important than the second information, or to 612 if control circuitry 304 determines that the second information is more important than the first information. In some embodiments, control circuitry 304 may transmit a command to the database (e.g., media guidance data source 418) to store the first information and second information in the database in a data structure that includes the known information. For example, control circuitry 304 may send the information learned, as discussed above and below, from image 500, to media guidance data source 418, and may instruct media guidance data source 418 to store the information in a data structure that includes information that was already stored at media guidance data source 418. As an example, if media guidance data source 418 previously listed Woody as the sole lead character, the command sent by control circuitry 304 would instruct media guidance data source to include Rex as a lead character as well, as Rex is prominently depicted in image 500.

In some embodiments, the command to media guidance data source 418 may additionally include an instruction to organize the first information, the second information, and the known information in the database based on the determined relative importance (as determined at 608). For example, if media guidance data source 418 previously reflected that Woody was the most prominent character in “Toy Story 4,” and control circuitry 304 determined that Rex is in fact a more prominent character than Woody is based on the relative emphasis of character 502 in image 500 as compared to the relative emphasis of character 504, the instruction sent to media guidance data source 418 by control circuitry 304 may include an instruction to list Rex as a first lead character in “Toy Story 4,” and Woody as a second lead character in “Toy Story 4,” thus causing media guidance data source 418 to organize the information learned by control circuitry 304 based on image 500, as well as the information previously known to media guidance data source 418, in order of relative importance.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 6.

It will be apparent to those of ordinary skill in the art that methods involved in the present invention may be embodied in a computer program product that includes a computer-usable and/or readable medium. For example, such a computer-usable medium may consist of a read-only memory device, such as a CD-ROM disk or conventional ROM devices, or a random access memory, such as a hard drive device or a computer diskette, having a computer-readable program code stored thereon. It should also be understood that methods, techniques, and processes involved in the present invention may be executed using processing circuitry. For instance, determination of relative importance of characters 502 or 504 may be determined, e.g., by processing circuitry 306 of FIG. 3. The processing circuitry, for instance, may be a general purpose processor, a customized integrated circuit (e.g., an ASIC), or a field-programmable gate array (FPGA) within user equipment 300, media content source 416, or media guidance data source 418. For example, the user profile information as described herein may be stored in, and retrieved from, storage 308 of FIG. 3, or media guidance data source 418 of FIG. 4. Furthermore, processing circuitry, or a computer program, may update settings associated with a user, such as user preferences of a user profile, updating the information stored within storage 308 of FIG. 3 or media guidance data source 418 of FIG. 4.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method for compiling metadata based on audio or visual information pertaining to a media asset, the method comprising:
receiving an image or audio that is associated with a media asset;
identifying a plurality of information that describes the media asset from the image or the audio;
retrieving known information about the media asset from a database;
determining a relative importance of first information of the plurality of information as compared to (1) second information of the plurality of information and (2) the known information; and
transmitting a command to the database to (1) store the first information and second information in the database in a data structure that includes the known information and (2) organize the first information, the second information, and the known information in the database based on the determined relative importance.

2. The method of claim 1, wherein determining the relative importance comprises:
determining a level of emphasis of the first information in the image or audio;
determining a level of emphasis of the second information in the image or audio;
comparing the level of emphasis of the first information to the level of emphasis of the second information;
determining that the level of emphasis of the first information is greater than the level of emphasis of the second information; and
determining that the first information is relatively more important than the second information.

3. The method of claim 2, wherein the level of emphasis of the first information is determined based on at least one of font size, font type, font color, object size, object color, object placement, depth of object with relation to a foreground or a background of an image, audio volume, and audio type.

4. The method of claim 1, further comprising:
identifying third information of the plurality of information;
determining a type of information of the third information;
retrieving data populated in a field of the known information, wherein the field corresponds to the determined type;
determining whether the third information matches to the retrieved data; and
replacing the retrieved data with the third information if the third information does not match the retrieved data.

5. The method of claim 1, further comprising:
identifying a context of each information of the plurality of information;
retrieving a mapping of a plurality of contexts to a plurality of genres;
determining a set of genres associated with the plurality of information by cross-referencing the context of each information the plurality of information against the mapping;
retrieving a plurality of genre weightings associated with the media asset from the database;
updating the plurality of genre weightings by incrementing each genre weighting for which a genre of the set of genres matches; and
transmitting a command to the database to replace the plurality of genre weightings with the updated plurality of genre weightings.

6. The method of claim 5, further comprising:
prior to updating the plurality of genre weightings, determining whether a genre of the set of genres is diametrically opposed to a genre with a genre weighting that is above a threshold; and
in response to determining that the genre of the set of genres is diametrically opposed to the genre with the genre weighting that is above the threshold, refraining from updating a genre weighting corresponding to the genre of the set of genres.

7. The method of claim 1, wherein identifying the plurality of information further comprises:
performing facial recognition on a face of the image to identify a person associated with the media asset; and
transmitting a command to the database to denote the identified person in the data structure as a person of importance.

8. The method of claim 1, wherein the image is a frame of a video associated with the media asset, and wherein the relative importance of the first information is based on the relative number of frames of the video that the first information is associated with as compared to the relative number of frames of the video that the second information is associated with.

9. The method of claim 1, further comprising:
retrieving a user profile associated with a user;
retrieving data of the data structure;
cross-referencing data of the user profile against the data of the data structure;
determining a recommendation based on the cross-referencing; and
causing the recommendation to be provided to the user.

10. The method of claim 1, further comprising:
receiving a request for information corresponding to the media asset;
retrieving data of the data structure; and
causing the generation of a display of information corresponding to the media asset, wherein the information is organized according to the determined relative importance.

11. A system for compiling metadata based on audio or visual information pertaining to a media asset, the system comprising:
communications circuitry; and
control circuitry configured to:
receive, using the communications circuitry, an image or audio that is associated with a media asset;
identify a plurality of information that describes the media asset from the image or the audio;
retrieve, using the communications circuitry, known information about the media asset from a database;
determine a relative importance of first information of the plurality of information as compared to (1) second information of the plurality of information and (2) the known information; and
transmit a command to the database to (1) store the first information and second information in the database in a data structure that includes the known information and (2) organize the first information, the second information, and the known information in the database based on the determined relative importance.

12. The system of claim 11, wherein the control circuitry is further configured, when determining the relative importance, to:
determine a level of emphasis of the first information in the image or audio;
determine a level of emphasis of the second information in the image or audio;
compare the level of emphasis of the first information to the level of emphasis of the second information;
determine that the level of emphasis of the first information is greater than the level of emphasis of the second information; and
determine that the first information is relatively more important than the second information.

13. The system of claim 12, wherein the control circuitry is further configured to determine the level of emphasis of the first information based on at least one of font size, font type, font color, object size, object color, object placement, depth of object with relation to a foreground or a background of an image, audio volume, and audio type.

14. The system of claim 11, wherein the control circuitry is further configured to:
identify third information of the plurality of information;
determine a type of information of the third information;
retrieve data populated in a field of the known information, wherein the field corresponds to the determined type;
determine whether the third information matches to the retrieved data; and
replace the retrieved data with the third information if the third information does not match the retrieved data.

15. The system of claim 11, wherein the control circuitry is further configured to:
identify a context of each information of the plurality of information;
retrieve a mapping of a plurality of contexts to a plurality of genres;
determine a set of genres associated with the plurality of information by cross-referencing the context of each information the plurality of information against the mapping;
retrieve a plurality of genre weightings associated with the media asset from the database;
update the plurality of genre weightings by incrementing each genre weighting for which a genre of the set of genres matches; and
transmit a command to the database to replace the plurality of genre weightings with the updated plurality of genre weightings.

16. The system of claim 15, wherein the control circuitry is further configured to:
prior to updating the plurality of genre weightings, determine whether a genre of the set of genres is diametrically opposed to a genre with a genre weighting that is above a threshold; and
in response to determining that the genre of the set of genres is diametrically opposed to the genre with the genre weighting that is above the threshold, refrain from updating a genre weighting corresponding to the genre of the set of genres.

17. The system of claim 11, wherein the control circuitry is further configured, when identifying the plurality of information, to:
perform facial recognition on a face of the image to identify a person associated with the media asset; and
transmit a command to the database to denote the identified person in the data structure as a person of importance.

18. The system of claim 11, wherein the image is a frame of a video associated with the media asset, and wherein the relative importance of the first information is based on the relative number of frames of the video that the first information is associated with as compared to the relative number of frames of the video that the second information is associated with.

19. The system of claim 11, wherein the control circuitry is further configured to:
retrieve a user profile associated with a user;
retrieve data of the data structure;
cross-reference data of the user profile against the data of the data structure;
determine a recommendation based on the cross-referencing; and
cause the recommendation to be provided to the user.

20. The system of claim 11, wherein the control circuitry is further configured to:
receive a request for information corresponding to the media asset;
retrieve data of the data structure; and
cause the generation of a display of information corresponding to the media asset, wherein the information is organized according to the determined relative importance.

21-50. (canceled)
